(19) United States
(12) Patent Application Publication
(10) Pub. No.: US 2004/0244701 A1
(43) Pub. Date: Dec. 9, 2004

(54) Bird feeder support system

(76) Inventor: Russell A. Greinke, Kingsley, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/849,951

(22) Filed: May 20, 2004

Related U.S. Application Data
(60) Provisional application No. 60/471,948, filed on May 20, 2003.
(60) Provisional application No. 60/487,824, filed on Jul. 16, 2003.

(51) Int. Cl. A01K 1/10

(52) U.S. Cl. 119/51.01

(57) ABSTRACT

An adjustable support system for a bird feeder comprises a support assembly that includes a support member adapted to be fixedly secured to a base structure, and an arcuately-shaped body member having a first end pivotally coupled to the support member and a second end extending outwardly from the support member. The support system further comprises a hanger assembly that includes a cable having a first end operably coupled to the body member along the length of the body member, and a second end adapted to support a bird feeder therefrom, and a planar member operably coupled to the cable along a length of the cable such that the planar member extends substantially orthogonal to the cable, wherein the planar member is adapted to prevent rodents from transiting the cable between the body member and the second end of the cable.

### CROSS REFERENCE TO RELATED APPLICATION

This application claims the benefit of U.S. Provisional Application No. 60/471,948, filed May 20, 2003, entitled ADJUSTABLE BIRD FEEDER, and U.S. Provisional Application No. 60/487,824, filed Jul. 16, 2003, entitled RODENT INHIBITOR FOR BIRD FEEDER which are hereby incorporated herein by reference in their entirety.

### BACKGROUND OF THE INVENTION

Numerous and various configurations of supports and hangers have been utilized to support bird feeders above associated supporting structures such as a deck or a post. These arrangements typically include a mounting component for securing the particular support and/or hanger to the supporting structure, and a supporting arm that extends above the mounting component and to which the associated bird feeder can be attached.

Heretofore, these supports and hangers have provided inadequate structural support, have by their design made it difficult to refill emptied bird feeders, have suspended the supported bird feeders directly over an associated and supporting deck, thereby allowing bird droppings and scattered seeds to litter the same, have provided little adjustability with respect to the positioning of the supported bird feeder relative to the underlying deck or post, and have provided little adaptability with respect to the bird feeders or other structures that may be suspended therefrom. Further, these arrangements have inadequately defended against access by rodents, such as squirrels, to the support feeders.

As a result, there is a need for a support system for a bird feeder that provides adequate structural support, allows the adjustment of the position of the supported bird feeder with respect to the supporting structure, is adaptable to supporting multiple bird feeders and/or other structures, and further that inhibits access by rodents, such as squirrels, to the associated feeder(s).

### SUMMARY OF THE INVENTION

One aspect of the present invention is to provide an adjustable support system for a bird feeder that comprises a support assembly including a support member adapted to be fixedly secured to a base structure, and an arcuately-shaped body member having a first end pivotally coupled to the support member and a second end extending outwardly from the support member. The support system further comprises a hanger assembly that includes a cable having a first end operably coupled to the body member along a length of the body member, and a second end adapted to support a bird feeder therefrom, and a planar member operably coupled to the cable along the length of the cable such that the planar member extends substantially orthogonal to the cable, wherein the planar member is adapted to prevent rodents from transiting the cable such that the planar member extends substantially orthogonal to the cable, wherein the planar member is adapted to prevent rodents from transiting the cable between the body member and the second end of the cable.

Another aspect of the present invention is to provide an adjustable support system for a bird feeder that comprises a support member adapted to be fixedly secured to a base structure, an arcuately-shaped body member having a first end pivotally coupled to the support member and a second end extending outwardly from the support member, and at least one hook member fixedly secured to and spaced along the length of the body member, wherein the hook is adapted to support a bird feeder therefrom.

Still another aspect of the present invention is to provide an adjustable support system for a bird feeder that comprises a cable having a first end adapted to be coupled to a support member, and a second end adapted to support a bird feeder therefrom, and a planar member operably coupled to the cable along a length of the cable such that the planar member extends substantially orthogonal to the cable, wherein the planar member is adapted to prevent rodents from transiting the cable between a support member and the second end of the cable.

The subject bird feeder support system provides adequate structural support, allows the adjustment of the position of the supported bird feeder with respect to the supporting structure, is adaptable to supporting multiple bird feeders and/or other structures, inhibits access to rodents, such as squirrels, to the associated feeder(s), and is particularly well adapted for the proposed use.

### BRIEF DESCRIPTION OF THE DRAWINGS

FIG. 1 is a perspective view of a bird feeder support system embodying the present invention;

FIG. 2 is a perspective view of a support member of the support system; and

FIG. 3 is an enlarged perspective view of a body member of the support system, and a container in dotted line supported thereon.

### DETAILED DESCRIPTION OF THE PREFERRED EMBODIMENTS

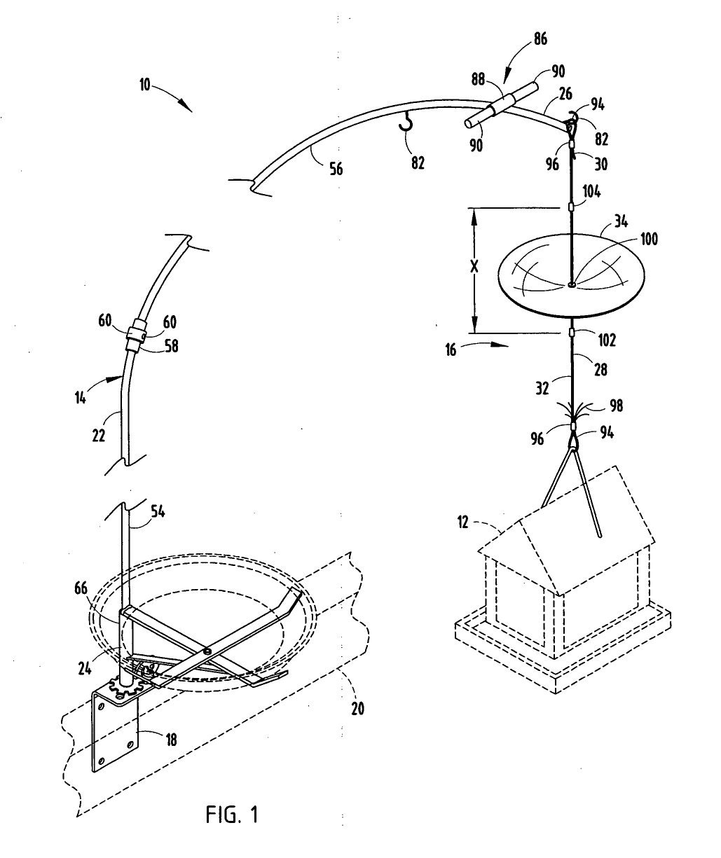

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

An adjustable support system 10 (FIG. 1) for a bird feeder 12 includes a support assembly 14 and a hanger assembly 16. The support assembly 14 includes a support member 18 adapted to be fixedly secured to a base structure 20, such as a structural member of a deck, a vertically-extending post, or the like. The support assembly 14 also includes an arcuately-shaped body member 22 having a first end 24 pivotally coupled to the support member 18 and a second end 26 extending outwardly from the support member 18. The hanger assembly 16 includes a cable 28 having a first end 30 operably coupled to the body member 22, and a second end 32 operably coupled to the bird feeder 12. The hanger assembly 16 also includes a planar member 34 operably coupled to the cable 28 along a length of the cable 28 such that the planar member 34 extends substantially orthogonal to the cable 28, and wherein the planar member 34 is adapted to prevent rodents from transiting the cable 28 between the body member 22 and the bird feeder 12.

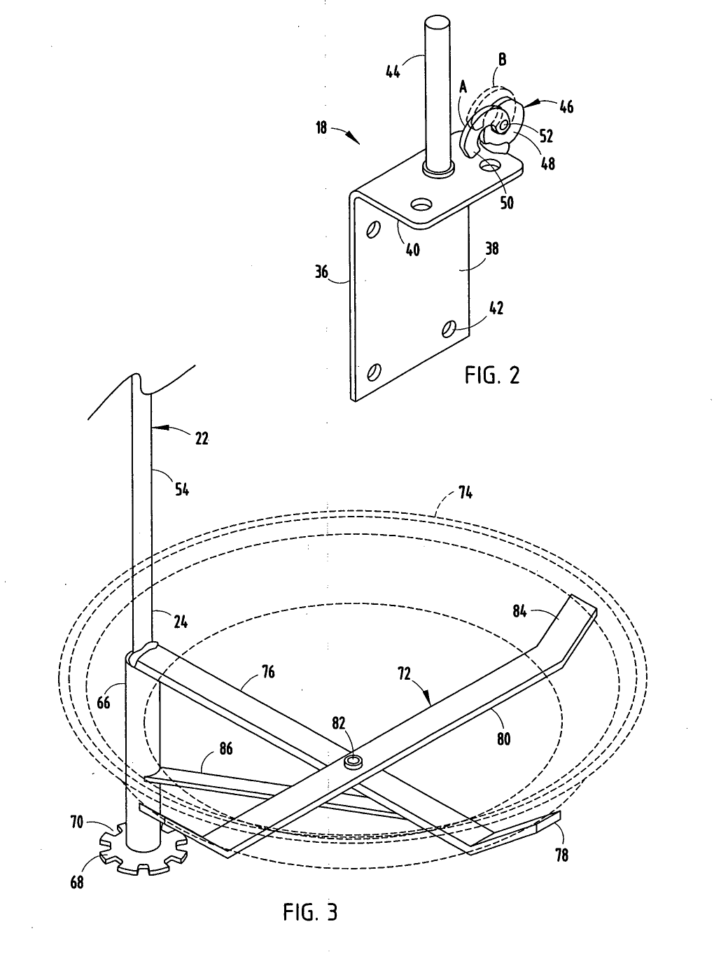

The support member 18 (FIG. 2) includes an L-shaped connector bracket 36 having a first portion 38 and a second portion 40 extending substantially orthogonal to the first portion 38. The first portion 38 and the second portion 40 of the bracket 36 each include a plurality of apertures 42 extending therethrough and adapted to receive mounting hardware such as lug bolts (not shown) for securely mounting the support member 18 to the base structure 20. The support member 18 also includes a pivot pin extending outwardly from and centrally located with respect to the second portion 40 of the bracket 36. Preferably, the pivot pin 44 is fixedly secured to the second portion 40 via a weld. A locking assembly 46 is fixedly secured to the second portion 40 proximate an edge thereof, and includes a fixed portion 48 fixedly secured to the second portion 40 of the bracket 36, and a lock portion 50 pivotally secured to the fixed portion 48 via a rivet 52, and operable between a locked position A and an unlocked position B, as described below.

The body member 22 includes a first portion 54 and a second portion 56 that are telescopingly mateable with one another and have a circular cross-sectional configuration. Specifically, a collar 58 having an inner diameter that is slightly greater than the outer diameter of the first portion 54 is secured via a weld to the second portion 56. A mechanical fastener such as a bolt or screw 60 extends through an aperture (not shown) of the collar 58 and a coaligned aperture (not shown) of the first portion 54, thereby securely fastening the second portion 56 to the first portion 54. The first portion 54 of the body member 22 further includes a journal 66 (FIG. 3) fixedly secured to the first end 24 of the body member 22 via a weld and having an inner diameter that is slightly greater than the outer diameter of the pivot pin 44 of the support member 18. A locking plate 68 is fixedly secured via a weld to an end of the journal 66 and includes a plurality of notches 70 spaced about the periphery thereof and adapted to receive the lock portion 50 of the locking assembly 46 therein, as described below. A synthetic-type washer 71 is located between the first end 24 of the body member 22 and the second portion 40 of the support member 18.

A frame assembly 72 is fixedly welded to the journal 66 and is configured and positioned so as to support a container 74, such as a bird bath or a potted plant, thereon. Specifically, the frame assembly 72 includes a first support arm 76 extending orthogonally outwardly from the journal 66 and including an upwardly-curved or angled outer end 78. The frame assembly 72 also includes a second support arm 80 orthogonally crossing the first support arm, and affixed thereto via a bolt or screw 82. The second support arm 80 includes a pair of upwardly-curved or bent outer ends 84. The first support arm 76 and the second support arm 80 cooperate to form a base upon which the container 74 is supported. A support bracket 86 extends angularly upward from the journal 66 to the first support arm 76, thereby structurally supporting the same and preventing deformation thereof. In use, the container 74 is placed upon the base as formed by the first support arm 76 and the second support arm 80 and is prevented from sliding from the base by the upwardly-curved or bent outer ends 78, 84 of the first support arm 76 and the second support arm 80, respectively. Alternatively, the bent outer ends 78, 84 may be configured so as to positively engage the container 74, such as by curving the end 78, 84 around an upper lip of the container 74.

The body member 22 further includes a perch 86 that includes a loop 88 fixedly welded to the second portion 56, and a perch bar 90 received within the loop 88 and extending outwardly from the body member 22. The body member 22 further includes a plurality of hooks 82 fixedly welded to the second portion 56 and spaced along the length thereof. The hooks 82 are adapted to hangingly support hanger assemblies 16, or other hangers adapted to support bird feeders and the like therefrom.

The first end 30 and the second end 32 of the cable 28 are each provided with a loop 94 that is constructed via cable crimps 96. The second end 32 of the cable 28 is extended beyond the associated cable crimp 96 to a distance of between 2 and 3 inches, where the second end 32 of the cable 28 is frayed into a plurality of outwardly-extending fingers 98 spaced circumferentially about the cable 28. The planar member 34 is preferably constructed of a light gauge stainless or galvanized steel and is provided a substantially circular plan form. The planar member 34 includes a centrally-located aperture 100 through which the cable 28 extends. A stop member 102 is secured along a length of the cable 28 below the planar member 34 and includes a plurality of outwardly-extending fingers (not shown) that prevent the planar member 34 from being slid along the cable 28 past the stop member 102. A similarly-constructed stop member 104 is located along the length of the cable 28 above the planar member 34 at a distance that allows the planar member 34 to slide along the length of cable 28 a distance X.

The subject bird feeder support system provides adequate structural support, allows the adjustment of the position of the supported bird feeder with respect to the supporting structure, is adaptable to supporting multiple bird feeders and/or other structures, inhibits access to rodents, such as squirrels, to the associated feeder(s), and is particularly well adapted for the proposed use.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. An adjustable support system for a bird feeder, comprising:
a support assembly, comprising:
a support member adapted to be fixedly secured to a base structure; and
an arcuately-shaped body member having a first end pivotably coupled to the support member and a second end extending outwardly from the support member; and
a hanger assembly, comprising:
a cable having a first end operably coupled to the body member along a length of the body member, and a second end adapted to support a bird feeder therefrom; and
a planar member operably coupled to the cable along a length of the cable such that the planar member extends substantially orthogonal to the cable, wherein the planar member is adapted to prevent rodents from transiting the cable between the body member and the second end of the cable.

2. The support system of claim 1, wherein the support assembly further comprises:
a locking mechanism movable between a locked position, wherein the locking mechanism prevents the body member from pivoting with respect to the support member, and an unlocked position, wherein the body member freely pivots with respect to the support member.

3. The support assembly of claim 2, wherein the locking mechanism includes a locking element pivotably coupled to the support member and that is selectively engagable with at least one notch located within the body member.

4. The support system of claim 1, wherein a select one of the support member and the body member includes a journal, and the remaining of the support member and the body member includes a pivot pin pivotably received within the journal.

5. The support system of claim 1, wherein the support assembly further comprises:
at least one hook member fixedly secured to the body member and supporting the first end of the cable.

6. The support assembly of claim 5, wherein the at least one hook member is located substantially proximate the second end of the body member.

7. The support system of claim 1, wherein the body member includes a first portion and a second portion, the first portion including the first end of the body member, the second portion including the second end of the body member, and wherein the first and second portion telescopingly mate with one another.

8. The support system of claim 1, wherein the support assembly further comprises:
a frame assembly including a first elongate support arm fixedly attached along the length of the body member and extending substantially orthogonal to the body member, wherein the first support arm is adapted to support a container thereon.

9. The support system of claim 8, wherein the frame assembly further includes a second support arm fixedly coupled to the first support, wherein the first and second support arms cooperate to form a base to support a container thereon.

10. The support system of claim 9, wherein the first bracket includes and angled outer end, the second bracket includes angled ends, and wherein the angled ends of the first and second brackets cooperate to prevent a container from sliding off the base.

11. The support assembly of claim 1, wherein the hanger assembly further comprises:
a plurality of fingers extending outwardly from and spaced about the cable located substantially proximate the second end of the cable.

12. The support system of claim 11, wherein the fingers comprise a frayed end of the cable.

13. The support system of claim 1, wherein the body member is able to pivot 3600 with respect to the support member.

14. An adjustable support system for a bird feeder, comprising:
a support member adapted to be fixedly secured to a base structure;
an arcuately-shaped body member having a first end pivotably coupled to the support member and a second end extending outwardly from the support member; and
at least one hook member fixedly secured to and spaced along a length of the body member, wherein the hook is adapted to support a bird feeder therefrom.

15. The support system of claim 14, wherein a select one of the support member and the body member includes a journal, and the remaining of the support member and the body member includes a pivot pin pivotably received within the journal.

16. The supporting system of claim 14, further comprising:
a locking mechanism movable between a locked position, wherein the locking mechanism prevents the body member from pivoting with respect to the support member, and an unlocked position, wherein the body member freely pivots with respect to the support member.

17. The support system of claim 16, wherein the locking mechanism includes a locking element pivotably coupled to the support member and that is selectively engagable with at least one notch located within the body member.

18. The support system of claim 14, wherein the at least one hook member is located substantially proximate the second end of the body member.

19. The support system of claim 14, wherein the body member includes a first portion and a second portion, the first portion including the first end of the body member, the second portion including the second end of the body member, and wherein the first and second portion telescopingly mate with one another.

20. The support system of claim 14, further comprising:
a frame assembly including a first elongate support arm fixedly attached along the length of the body member and extending substantially orthogonal to the body member, wherein the first support arm is adapted to support a container thereon.

21. The support system of claim 20, wherein the frame assembly further includes a second support arm fixedly coupled to the first support arm, wherein the first and second support arms cooperate to form a base to support a container thereon.

22. The support system of claim 21, wherein the first support arm includes and angled outer end, the second support arm includes angled ends, and wherein the angled ends of the first and second support arms cooperate to prevent a container from sliding off the base.

23. An adjustable supporting system for a bird feeder, comprising:
a cable having a first end adapted to be coupled to a support member, and a second end adapted to support a bird feeder therefrom; and
a planar member operably coupled to the cable along a length of the cable such that the planar member extends substantially orthogonal to the cable, wherein the planar member is adapted to prevent rodents from transiting the cable between a support member and the second end of the cable.

24. The support system of claim 23, wherein the cable extends through an aperture within the planar member.

25. The support system of claim 24, wherein the aperture is substantially centrally located with respect to the planar member.

26. The support system of claim 25, wherein the planar member comprises a substantially circular plan form shape.

27. The support system of claim 23, wherein the hanger assembly further comprises:
a plurality of fingers extending outwardly from and spaced about the cable located substantially proximate the second end of the cable.

28. The support system of claim 27, wherein the fingers comprise a frayed end of the cable.
